(19) United States
(12) Patent Application Publication
(10) Pub. No.: US 2020/0276616 A1
(43) Pub. Date: Sep. 3, 2020

(54) SORTING ARTICLES USING SORTERS IN PARALLEL WITH DIVIDED AND CROSSED PASSES

(71) Applicant: SOLYSTIC, Bagneux (FR)

(72) Inventors: Didier TRESSE, Saint Laurent d'Onay (FR); Jérôme SOUQUIERES, Bourg Les Valence (FR); François MADAR, Bourg Les Valence (FR); Richard BLACHE, Lemps (FR)

(21) Appl. No.: 16/804,469

(22) Filed: Feb. 28, 2020

(30) Foreign Application Priority Data
Feb. 28, 2019 (FR) 1902053

(51) Int. Cl. B07C 3/00; B07C 5/38; B07C 5/36

(52) U.S. Cl. CPC B07C 3/003; B07C 2301/0041; B07C 5/362; B07C 5/38

(57) ABSTRACT

A method of sorting articles to be prepared into delivery rounds by means of at least first and second sorters (T1, T2), which method consists in distributing (St10) said articles between said sorters, in performing (St20) a first sorting pass (P1) for sorting the articles in parallel on the first sorter and on the second sorter, in retrieving (St30) first groups (G1) of articles at first sorting outlets (S1) of the first and second sorters, in bringing said first groups to the inlet (E) of the first sorter (T1), in retrieving (St30) second groups (G2) of articles at second sorting outlets (S2) of the first sorter and of the second sorter, in bringing said second groups to the inlet (E) of the second sorter (T2), and then in performing (St40) successive sorting passes (P2, P3) in parallel on the first sorter and on the second sorter until the preparation of the articles into delivery rounds is complete.

### CROSS REFERENCE TO RELATED APPLICATIONS

This application claims priority under 35 USC § 119 to French Patent Application No. 1902053 filed on Feb. 28, 2019, which application is hereby incorporated by reference in its entirety

### TECHNICAL FIELD

The invention relates to the field of methods of sorting articles to be prepared into delivery rounds by means of at least two sorters.

### PRIOR ART

In order to receive postal articles coming from various sources and in order to deliver them to a large number of recipients, postal organizations firstly gather the received articles together and, as a function of the geographical regions of their destinations, route them or “outwardly sort” them towards sorting centers, where they are arranged in delivery sequences.

At the sorting centers, the articles to be delivered undergo an “inward sorting” phase, during which the articles are separated into groups, and then undergo a “sequencing” phase, during which each group is processed individually in a dedicated sorter so as to arrange the articles into sequences, typically so as to prepare delivery rounds or “postmen's walks”, also known as “mail carrier walks”.

In practice, a sorter performs a plurality of successive sorting passes on any given group of articles, each group being sorted a first time, being retrieved at the outlets of the sorter, and then being brought back to the inlet of the same sorter and re-sorted by it, this operation being reiterated as many times as is necessary for completing the sequencing operation.

In the current context of gradual reduction in the amount of mail sent by post, the main limiting factor for sorting systems is no longer the quantity of mailpieces to be processed, but rather the number of delivery points to which the mailpieces can be addressed.

The number of delivery points that can be handled by a sorter, i.e. the number of delivery points for which a single sorter can arrange articles in a sequence, is limited by two factors, namely the number of outlets of the sorter, and the number of sorting passes effected by said sorter on a given batch of articles.

It is known that the maximum number Dₘₐₓ of delivery points that can be handled by a sorter for preparing articles in sequences is Dₘₐₓ=S^{P}, where S is the number of outlets of the sorter and P is the number of sorting passes.

Reference may be made to U.S. Pat. No. 7,170,024, which discloses a method of sorting articles into sequences that includes sorters working in parallel.

Two conventional solutions exist for increasing the number of delivery points that can be handled by a sorter: increasing the number S of outlets or increasing the number P of sorting passes.

The first solution increases not only the number of outlets but also the cost of and the footprint of the sorting installations, where the “footprint” is the floor area occupied by such installations.

The second solution also considerably increases the time taken for the operations for putting the mailpieces into sequences, thereby reducing the operating throughput rate and increasing the costs.

The solution of implementing virtual systems on a single sorter also exists, but that solution is also unsatisfactory because it is limited by the operating throughput rate of the sorter and/or it requires the sorter to have a particular design so as to enable its throughput rate to be increased, the single sorter also becoming a critical element for sorting operations in which any defectiveness or failure implies a loss of throughput rate for all of the operations.

### SUMMARY OF THE INVENTION

An object of the invention is to provide a method of sorting articles to be prepared into delivery rounds that enables the number of delivery points handled to be increased substantially, without that being at the cost of an increase in the number of outlets or in the time taken to prepare the delivery rounds.

To this end, the invention provides a method of sorting articles to be prepared into delivery rounds in a plurality of sorting passes, said method being characterized in that it uses at least a first sorter and a second sorter, each of which having sorting outlets, the method comprising the steps of:
distributing said articles between said first and second sorters;
performing a first sorting pass for sorting the distributed articles on the first sorter and on the second sorter, this first sorting pass taking place simultaneously on the first sorter and on the second sorter;
retrieving first groups of articles at the first sorting outlets of the first sorter and at the first sorting outlets of the second sorter, and bringing said first groups of articles to the inlet of the first sorter; and
retrieving second groups of articles at the second sorting outlets of the first sorter and at the second sorting outlets of the second sorter, and bringing said second groups of articles to the inlet of the second sorter; and then
performing successive sorting passes in parallel on the first sorter and on the second sorter on the groups of articles brought to the inlets of said sorters, each batch of articles formed at an outlet of a sorter at the end of one of the sorting passes being retrieved and sent back to the inlet of the same sorter to be sorted again, until the preparation of the articles into delivery rounds is complete.

The sorting method of the invention is thus based on crossing flows of articles between two sorters at the end of a first pass, that crossing being followed by successive sorting passes using a conventional method during which a set of articles is processed in a plurality of passes by the same sorter.

A first advantage of such crossing is to increase the number of delivery points processed by two sorters, compared with a reference of a single sorter having a number of outlets equal to the sum of the number of outlets of the two sorters, and without substantially increasing the footprint.

A second advantage is that, in addition to increasing the number of delivery points handled, the processing time that is necessary is reduced compared to the processing time required with a single sorter, as described in detail below.

The sorting method of the invention may have the following features:
preparing said delivery rounds may be performed by means of two sorters and of three sorting passes;
allocating the outlets to destinations may follow a dynamic allocation method; and
the articles may be postal articles.

### BRIEF DESCRIPTION OF THE DRAWINGS

The present invention can be better understood and other advantages appear on reading the following detailed description of an implementation given by way of non-limiting example and with reference to the accompanying drawings, in which:

FIG. 1 shows the steps of a sorting method of the invention.

FIG. 2 is a flow chart showing the steps of FIG. 1; and

FIG. 3 shows a comparison between the method of the invention and a conventional method.

### DESCRIPTION OF AN IMPLEMENTATION OF THE METHOD OF THE INVENTION

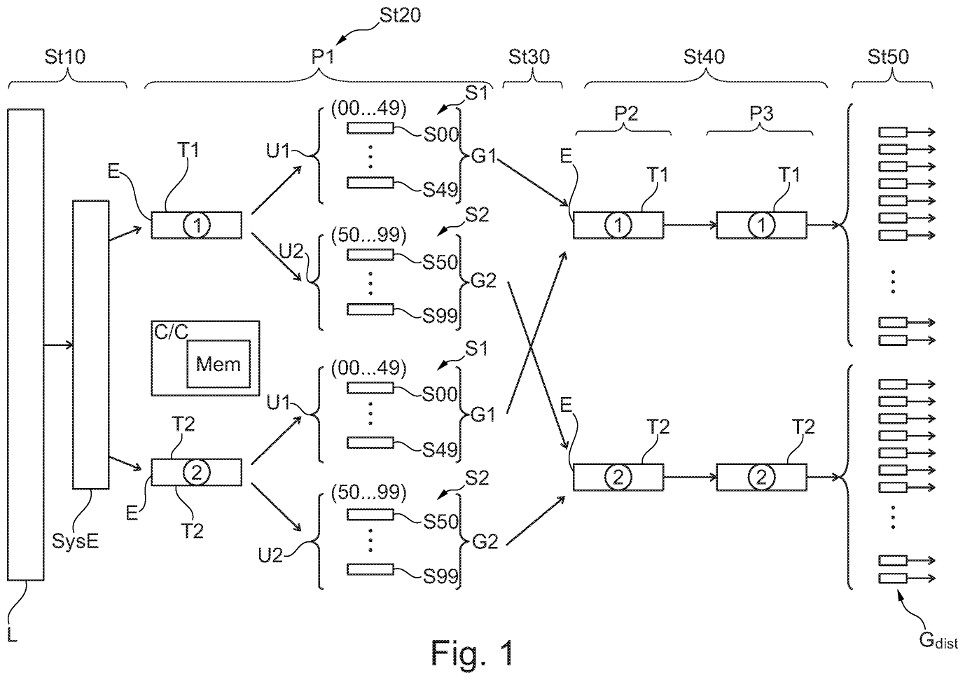

FIG. 1 shows an implementation of the method of the invention, in the particular situation when a first sorter T1 and a second sorter T2 are used in parallel in three sorting passes P1, P2 and P3 for preparing a batch L of articles into delivery rounds, the first sorter and the second sorter being identical, and each having a set U1 of sorting outlets S1 and a set U2 of sorting outlets S2.

For illustration purposes, we consider that each of the two sorters T1 and T2 has an inlet E and a number of outlets equal to 100, the sorting outlets being referenced S00 to S99 and being shared between first sorting outlets S1, referenced S00 to S49 in this example, and second sorting outlets S2, referenced S50 to S99 in this example.

The sorters are controlled by a monitoring and control unit C/C including a computer memory Mem that stores sorting plans, each of which establishes correspondences firstly between the delivery rounds and the destination addresses (delivery points) of the articles to be prepared into said delivery rounds, and secondly between the delivery rounds and the outlets of the sorters.

The monitoring and control unit controls the sorters in such a manner that the sorting complies with the sorting plans stored in the memory.

The sorters may be equipped with sensors that are connected to the monitoring and control system and that serve to identify and track the articles to be sorted, using conventional methods.

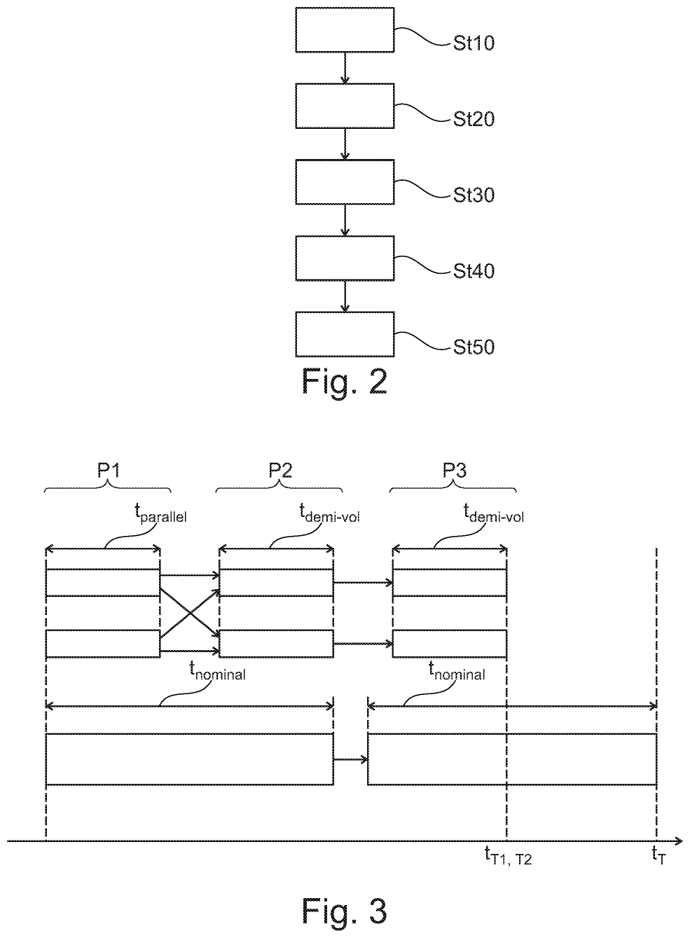

The succession of the steps of the method are shown diagrammatically in FIG. 2, with a first sorting pass being performed by two sorters after articles to be sorted have been distributed into two batches, each batch being for one of the two sorters, and then the articles being crossed selectively between the two sorters and being sorted in successive sorting passes.

In a distribution first step St10, the articles forming the batch L of articles to be prepared into delivery rounds are distributed over the two sorters T1 and T2, manually or automatically, e.g. by them being poured loose onto and then singulated on conveyors constituting an inlet system SysE using conventional methods.

The articles may be parcels to be delivered or postal articles such as letter-type mailpieces to be delivered to postal addresses, in which case it is possible to use an unstacker and/or a first sorting machine as an inlet system SysE.

Unless information is available a priori on how the articles should be distributed between the delivery points, it is preferable to distribute said articles uniformly between two sorters, so that said sorters have substantially the same workload.

In a step St20 of performing a first sorting pass P1 of the method, the articles distributed between the sorters undergo, in parallel, a first sorting pass by means of the first sorter and of the second sorter, the first sorting pass taking place simultaneously on the first sorter and on the second sorter for all of the delivery points.

For this first sorting pass, each delivery point is assigned exclusively either to one of the first outlets S1 or to one of the second outlets S2, both for the first sorter T1 and for the second sorter T2, in compliance with a first sorting plan.

Thus, given delivery points are assigned to the outlet Snn of the first sorter T1 and to the outlet Snn of the second sorter T2, where nn is an integer lying in the range 00 to 99, so that articles addressed to those delivery points are sorted to and grouped together at the two outlets Snn at the end of the first sorting pass.

More generally, in this implementation, the groups of articles formed at the outlets of the first sorter are formed using the same sorting criteria as for the groups formed at the corresponding outlets of the second sorter, e.g. by assigning the same delivery points to the same outlets of the two sorters.

This implementation may also be applied when the outlets are logic destinations that should then be allocated dynamically using a conventional dynamic allocation principle.

In a crossing step St30 following the first sorting pass, first groups G1 of articles are retrieved at the first sorting outlets S1 of the first sorter T1 and at the first sorting outlets S1 of the second sorter T2, the outlets S00 to S49 in this example, and these first groups G1 of articles are brought to the inlet of the first sorter T1, and, in similar manner, second groups G2 of articles are retrieved at the second sorting outlets S2 of the first sorter T1 and at the second outlets S2 of the second sorter T2, the outlets S50 to S99 in this example, and these second groups G2 of articles are brought to the inlet of the second sorter T2.

In this manner, the articles that are for the same delivery round and that were separated between two sorters T1 and T2 can be gathered together on the same sorter, either the sorter T1 or the sorter T2 in our example, in compliance with a second sorting plan that assigns the delivery points exclusively to one or the other of the sorters for the sorting passes following the first pass.

The delivery rounds and the second sorting plan are preferably calculated in such a manner that, at the end of the sorting, the articles constituting any given delivery round all find themselves at an outlet of a single one of the two sorters, and separated physically from the articles of the other rounds, e.g. by the articles being placed in trays that are each dedicated to only one of the rounds.

The first sorting pass leads to 100 groups being formed by the two sorters combined for a total number of outlets of 200, 50 of these groups, retrieved at the outlets S00 to S49 of the sorters, being brought to the inlet of the first sorter, and the other 50 groups, retrieved at the outlets S00 to S49 of the sorters, being brought to the inlet of the second sorter with a view to performing subsequent sorting passes P2 and P3, as shown in FIG. 1.

To perform the crossing step, it is possible to handle the groups of articles at the outlets of the sorters by hand, by conveyor means and/or by mechanisms that are fully or partially automated, or indeed by means of shuttle robots, using methods known to the person skilled in the art.

In a step St40 of performing successive sorting passes following the first sorting pass P1 and the crossing, successive sorting passes are performed in parallel on the first sorter and on the second sorter on the groups of articles brought to the inlets of the sorters, each group of articles formed at an outlet of a sorter at the end of one of the sorting passes being retrieved and sent back to the inlet of the same sorter so as to be sorted again, until the arrangement of the articles in sequence is complete, in compliance with the above-mentioned second sorting plan.

By means of the first sorting pass and of the crossing step taking into account the second sorting plan, each sorter only handles one half of the delivery points and one half of the articles to be sorted, as against all of the delivery points in the first sorting pass, which doubles the separating power of each of the subsequent sorting passes compared with the first pass and thus increases the efficiency of each sorting pass accordingly.

In this implementation of the method, two successive sorting passes P2 and P3 are performed, which is generally a sufficient number to satisfy a broad range of practical needs in view of the number of outlets that conventional sorters have.

Applying the above-mentioned formula Dₘₐₓ=S^{P} to the three sorting passes of this implementation indicates that the maximum number of delivery points that can be processed by the two sorters having 100 outlets in parallel in 3 passes is 1,000,000.

It is important to note that this high number of delivery points that can be handled is obtained without significantly increasing the footprint, or the cost of the sorting installations, or the time taken to prepare the delivery rounds compared with conventional solutions, as explained in the detailed comparison below.

During a step St50 following the successive sorting passes, the groups of articles G_{dist} formed at the outlets of the sorters are retrieved, optionally packaged, and then dispatched to their destinations in compliance with the delivery round to which they belong, using conventional methods.

### Comparative Example

In order to assess the advantages of the method of the invention, let us consider a comparison between the two sorters T1 and T2 used on three passes including the crossing step of the above-described implementation, and a single sorter T having one inlet and as many outlets as the two sorters T1 and T2 combined, i.e. a number of outlets Nₛ when T1 and T2 have Nₛ/2 outlets each, and assuming that, apart from the numbers of their sorting outlets, the sorters have identical technical characteristics.

The maximum number of delivery points that can be processed by the two sorters T1 and T2 in the implementation of the invention that is described in detail above is then:

Dₘₐₓ(T1,T2,3 passes)=2×(Nₛ/4)×(Nₛ/2)×(Nₛ/2)

i.e.:

Dₘₐₓ(T1,T2,3 passes)=(Nₛ/8)×Nₛ²

to be compared with the number of delivery points Dₘₐₓ(T, 2 passes) that can be processed in 2 passes by the single sorter T with:

Dₘₐₓ(T,2 passes)=Nₛ²

where, we observe that:

Dₘₐₓ(T1,T2,3 passes)=(Nₛ/8)×Dₘₐₓ(T,2 passes).

Assuming that Nₛ is 200 as in the example shown in FIG. 1, this being an order of magnitude commonly used in the field of postal sorting, then we observe that the two sorters T1 an T2 can process 1,000,000 delivery points in 3 passes, i.e. 25 times more than the single sorter T in 2 passes.

Each of the sorters T, T1 and T2 in question has an operating throughput rate of D articles per hour, for a sorting pass having a volume of N_{O} articles, and it is therefore necessary to have:
a time tₙₒₘᵢₙₐₗ=N_{O}/D for a sorting pass;
a time tₚₐᵣₐₗₗₑₗ=N_{O}/(2×D) for performing a sorting pass on the two sorters T1 and T2 in parallel; and
a time t_{half-vol} or t_{demi-vol}=(N_{O}/2)/D for performing a sorting pass on a half-volume of N_{O}/2 articles.

The total time tₜₒₜₐₗ for the three sorting passes on the two sorters T1 and T2 is then:

t_{T1,T2}=tₚₐᵣₐₗₗₑₗ+2×t_{half-vol}=1.5×N_{O}/D

to be compared with the total time t_{T} for two sorting passes on the single sorter T that is equal to 2×N_{O}/D, as shown in FIG. 3.

We observe that the use of the two sorters T1 and T2 in parallel in the method of the invention makes it possible to process considerably more outlet points than a single sorter while also completing the sequencing operation more quickly.

Strictly speaking, the additional time for the crossing step should also be taken into account, but since most of the time for processing the articles is taken up by the sorting passes, taking into account this additional time would not change the conclusion of this comparison qualitatively.

The first sorting pass and the crossing step make it possible to perform pre-sorting of the set of articles on the set of delivery points and to distribute pre-sorted groups of these articles in such a manner as to handle them in parallel on sorters dedicated to sub-sets of the delivery points, thereby increasing the overall speed of processing while also increasing the number of delivery points that can be handled.

Naturally, this conclusion is not limited to the example given above of two sorters put in parallel over three sorting passes.

The two sorters T1 and T2 are of the same design as the single sorter T and therefore occupy a floor area or “footprint” that is not significantly larger than said single sorter.

Furthermore, the method of the invention does not need any particular adaptation to be made to the pre-existing sorters in order to be implemented.

The above example is considered in the particular situation of two identical sorters used for three sorting passes, for explanation purposes, but the person skilled in the art can understand that the invention can be generalized to different numbers of sorters and to sorters having different characteristics, and to different numbers of sorting passes, the essential feature being to sort a set of articles distributed over a plurality of sorters working in parallel in successive passes, each sorter handling all of the delivery points of the articles during the first sorting pass and only a sub-set of those points for the subsequent passes, each sorter, during a crossing step immediately consecutive to the first sorting pass, receiving the articles sorted by the other sorters and addressed to the assigned delivery points, exclusively, at the outlets of the sorter in question for the subsequent passes.

The practical operator or user can determine the number of sorters and the number of sorting passes to be used, depending on needs and on specific constraints.

What is claimed is:

1. A method of sorting articles to be prepared into delivery rounds in a plurality of sorting passes, said method using at least a first sorter and a second sorter, each sorter having sorting outlets, the method comprising the steps of:
distributing said articles between said first and second sorters;
performing a first sorting pass for sorting the distributed articles on the first sorter and on the second sorter, this first sorting pass taking place simultaneously on the first sorter and on the second sorter;
retrieving first groups of articles at the first sorting outlets of the first sorter and at the first sorting outlets of the second sorter, and bringing said first groups of articles to the inlet of the first sorter; and
retrieving second groups of articles at the second sorting outlets of the first sorter and at the second sorting outlets of the second sorter, and bringing said second groups of articles to the inlet of the second sorter; and then
performing successive sorting passes in parallel on the first sorter and on the second sorter on the groups of articles brought to the inlets of said sorters, each batch of articles formed at an outlet of a sorter at the end of one of the sorting passes being retrieved and sent back to the inlet of the same sorter to be sorted again, until the preparation of the articles into delivery rounds is complete.

2. The method of sorting the articles according to claim 1, wherein preparing the articles into sequences is performed by two sorters and by three sorting passes.

3. The method of sorting articles according to claim 1, wherein allocating the outlets to destinations follows a dynamic allocation method.

4. The method of sorting articles according to claim 1, wherein the articles are postal articles.
